(19) United States
(12) Patent Application Publication
(10) Pub. No.: US 2006/0265498 A1
(43) Pub. Date: Nov. 23, 2006

(54) Detection and prevention of spam

(76) Inventors: Yehuda Turgeman, Alfei Menashe (IL); David Drai, Kfar Yona (IL); Amir Lev, Ein Vered (IL)

Correspondence Address: DARBY & DARBY P.C., P. O. BOX 5257, NEW YORK, NY, 10150-5257, US

(21) Appl. No.: 10/540,735

(22) PCT Filed: Dec. 25, 2003
(86) PCT No.: PCT/IL03/01103

§ 371 Date: Feb. 28, 2006

Related U.S. Application Data
(60) Provisional application No. 60/436,021, filed on Dec. 26, 2002.
(60) Provisional application No. 60/488,354, filed on Jul. 17, 2003.
(60) Provisional application No. 60/489,165, filed on Jul. 21, 2003.

(51) Int. Cl. G06F 15/173

(52) U.S. Cl. 709/225

(57) ABSTRACT

A method and system for combating spam, including obtaining information contained in messages, employing a variable criteria to the information, encrypting at least part of the information employing a non-reversible encryption so as to generate encrypted information, transmitting at least the encrypted information to a server for spam indication thereby receiving from the server classification data and determining the spam classification of the messages at least partially based on the classification data.

### REFERENCE TO CO-PENDING APPLICATIONS

This application claims priority from the following co-pending U.S. Patent Applications:

U.S. Provisional application Ser. No. 60/436,021, entitled “PREVENTION OF BULK TRANSMISSION OF OBJECTS IN A COMMUNICATION NETWORK”, filed Dec. 26, 2002, U.S. Provisional application Ser. No. 60/488,354, entitled “DETECTION AND PREVENTION OF SPAM AND BULK MESSAGES”, filed Jul. 17, 2003, and U.S. Provisional application Ser. No. 60/489,165, entitled “DETECTION AND PREVENTION OF SPAM AND BULK MESSAGES”, filed Jul. 21, 2003.

### FIELD OF THE INVENTION

The present invention relates to classification of messages in a communication network generally and more particularly to classification of messages as spam.

### BACKGROUND OF THE INVENTION

The following U.S. patents are believed to represent the state of the art:

U.S. Pat. Nos. 6,330,590; 6,421,709; 6,453,327; 6,460,050 and 6,622,909.

### SUMMARY OF THE INVENTION

The present invention seeks to provide a method and system for detecting the bulk transmission of objects in a communication network and preventing or avoiding further transmission of these objects.

There is thus provided in accordance with a preferred embodiment of the present invention a method for combating spam including classifying a message at least partially by evaluating at least one message parameter, using at least one variable criterion, thereby providing a spam classification and handling the message based on the spam classification.

In accordance with another preferred embodiment of the present invention the at least one variable criterion includes a criterion which changes over time. Additionally or alternatively, the at least one variable criterion includes a parameter template-defined function.

There is also provided in accordance with another preferred embodiment of the present invention a method for combating spam including classifying messages at least partially by evaluating at least one message parameter of multiple messages, by employing at least one evaluation criterion which change over time, thereby providing spam classifications and handling the messages based on the spam classifications.

In accordance with another preferred embodiment of the present invention the classifying is at least partially responsive to similarities between plural messages among the multiple messages, which similarities are reflected in the at least one message parameter. Alternatively or additionally, the classifying is at least partially responsive to similarities between plural messages among the multiple messages, which similarities are reflected in outputs of applying the at least one evaluation criterion to the at least one message parameter. Alternatively or additionally, the classifying is at least partially responsive to similarities in multiple outputs of applying a single evaluation criterion to the at least one message parameter in multiple messages. In accordance with another preferred embodiment of the present invention the classifying is at least partially responsive to the extent of similarities between plural messages among the multiple messages which similarities are reflected in the at least one message parameter. Alternatively or additionally, the classifying is at least partially responsive to the extent of similarities between plural messages among the multiple messages which similarities are reflected in outputs of applying the at least one evaluation criterion to the at least one message parameter. In accordance with yet another preferred embodiment of the present invention the classifying is at least partially responsive to the extent of similarities in multiple outputs of applying a single evaluation criterion to the at least one message parameter in multiple messages.

In accordance with still another preferred embodiment of the present invention the extent of similarities includes a count of messages among the multiple messages which are similar.

In accordance with another preferred embodiment of the present invention the classifying is at least partially responsive to similarities in outputs of applying evaluation criteria to the at least one message parameter in multiple messages, wherein a plurality of different evaluation criteria are individually applied to the at least one message parameter in the multiple messages, yielding a corresponding plurality of outputs indicating a corresponding plurality of similarities among the multiple messages. Additionally, the classifying also includes aggregating individual similarities among the plurality of similarities. Additionally, the aggregating individual similarities among the plurality of similarities includes applying weights to the individual similarities. Alternatively, the aggregating individual similarities among the plurality of similarities includes calculating a polynomial over the individual similarities.

In accordance with yet another preferred embodiment of the present invention the classifying is at least partially responsive to extents of similarities in outputs of applying evaluation criteria to the at least one message parameter in multiple messages, wherein a plurality of different evaluation criteria are individually applied to the at least one message parameter in the multiple messages, yielding a corresponding plurality of outputs indicating a corresponding plurality of extents of similarities among the multiple messages. Additionally, the classifying also includes aggregating individual extents of similarities among the plurality of extents of similarities. Additionally, the aggregating individual extents of similarities among the plurality of extents of similarities includes applying weights to the individual extents similarities. Alternatively, the aggregating individual extents of similarities among the plurality of extents of similarities includes calculating a polynomial over the individual extents of similarities.

Preferably, the extents of similarities include a count of messages among the multiple messages which are similar.

In accordance with still another preferred embodiment of the present invention the criteria include a parameter template-defined function.

In accordance with another preferred embodiment of the present invention the classifying employs a function of outputs of evaluating at least one message parameter of the multiple messages. Additionally, the classifying is at least partially responsive to similarities between outputs of the evaluating at least one message parameter of multiple messages.

In accordance with yet another preferred embodiment of the present invention the classifying includes the using at least one variable criterion at at least one gateway and the providing spam classifications at at least one server, receiving evaluation outputs from the at least one gateway and providing the spam classifications to the at least one gateway. Additionally, the classifying also includes encrypting at least part of the evaluation outputs by employing a non-reversible encryption so as to generate encrypted information and transmitting at least the encrypted information to the at least one server.

In accordance with another preferred embodiment of the present invention the transmitting includes transmitting information of a length limited to a predefined threshold.

There is further provided in accordance with another preferred embodiment of the present invention a method for combating spam including categorizing incoming messages received at at least one gateway into at least first, second and third categories, providing spam classifications for incoming messages in at least the first and second categories, not immediately providing a spam classification for incoming messages in the third category, storing incoming messages in the third category and thereafter providing spam classifications for the incoming messages in the third category. In accordance with another preferred embodiment of the present invention the method also includes handling the incoming messages based on the spam classifications.

In accordance with another preferred embodiment of the present invention the providing a spam classification for the incoming messages in the third category also includes providing a spam classification for a second message received at the at least one gateway. In accordance with another preferred embodiment of the present invention the method also includes waiting up to a predetermined period of time between the providing spam classifications for incoming messages in at least the first and second categories and the thereafter providing a spam classification for the incoming messages in the third category.

In accordance with another preferred embodiment of the present invention the categorizing includes at least one of requesting feedback from an addressee of the messages, evaluating compliance of the messages with a predefined policy, evaluating registration status of at least one registered address in the messages, analyzing a match among network references in the messages, analyzing a match between at least one translatable address in the messages and at least one other network reference in the messages, at least partially actuating an unsubscribe feature in the messages, analyzing an unsubscribe feature in the messages, employing a variable criteria, sending information to a server and receiving categorization data based thereon, employing categorization data received from a server and employing stored categorization data.

There is yet further provided in accordance with another preferred embodiment of the present invention a method for combating spam including classifying a message at least partially by relating to an unsubscribe feature in the message, thereby providing spam classifications for the message and handling the message based on the spam classifications.

In accordance with another preferred embodiment of the present invention the classifying also includes identifying whether the message includes an unsubscribe feature. Alternatively or additionally, the classifying also includes identifying whether the unsubscribe feature includes a reference to an addressee of the message. Additionally, the reference to an addressee of the message includes an e-mail address. Alternatively, the reference to an addressee of the message includes a per-addressee generated ID. Additionally, the per-addressee generated ID includes a user identification number.

There is even further provided in accordance with yet another preferred embodiment of the present invention a method for combating spam including classifying a message at least partially by at least partially actuating an unsubscribe feature in the message, thereby providing spam classifications for the messages and handling the message based on the spam classifications.

In accordance with another preferred embodiment of the present invention the classifying includes analyzing an output of the at least partial actuating. Additionally, the analyzing an output of the at least partially actuating includes sensing whether part of the output indicates the occurrence of an error. In accordance with another preferred embodiment of the present invention the at least partially actuating also includes at least attempting communication with a network server.

In accordance with a preferred embodiment of the present invention the error indicates that the network server does not exist. Alternatively, the error indicates that the network server does not provide an unsubscribe functionality. Alternatively, the error indicates that the network server cannot unsubscribe a message addressee.

In accordance with another preferred embodiment of the present invention the analyzing an output of the at least partially actuating includes sensing whether part of the output includes an addressee reference. Preferably, the addressee reference includes an e-mail address. Alternatively, the addressee reference includes a per-addressee generated ID. Additionally, the per-addressee generated ID includes a user identification number.

In accordance with yet another preferred embodiment of the present invention the analyzing an output of the at least partially actuating also includes relating the addressee reference to at least one addressee reference characteristic of the message. Additionally, the at least one addressee reference characteristic of the message includes an e-mail address. Alternatively, the at least one addressee reference characteristic of the message includes a per-addressee generated ID. Additionally, the per-at least one addressee reference characteristic of the per-addressee generated ID includes a user identification number.

In accordance with another preferred embodiment of the present invention the classifying also includes recognizing the unsubscribe feature. Additionally, the recognizing the unsubscribe feature includes sensing a part of the message including predefined keywords. Alternatively or additionally, the recognizing the unsubscribe feature includes sensing a part of the message including a network reference and a reference to an addressee of the messages. In accordance with another preferred embodiment of the present invention the network reference includes a reference to a network server. Additionally or alternatively, the reference to an addressee of the message includes an addressee e-mail address.

There is still further provided in accordance with another preferred embodiment of the present invention a method for combating spam including classifying a message at least partially by relating to registration status of at least one registered address in the message, thereby providing a spam classification for the message and handling the message based on the spam classifications.

In accordance with another preferred embodiment of the present invention the classifying includes employing a network service for determining the registration status. Additionally or alternatively, the registration status includes a registration date. Alternatively or additionally, the registration status includes a registration expiry date.

In accordance with another preferred embodiment of the present invention the classifying includes inspecting whether registration of the registered address has expired. Alternatively, the classifying includes inspecting whether the registered address has not been registered. In accordance with another preferred embodiment of the present invention the classifying includes comparing the registration date to a predefined date. In accordance with another preferred embodiment of the present invention the predefined date is a current date.

In accordance with a preferred embodiment of the present invention the registered address includes an Internet domain name. In accordance with another preferred embodiment of the present invention the Internet domain name is parked.

There is also provided in accordance with still another preferred embodiment of the present invention a method for combating spam including classifying a message at least partially by relating to a match among network references in the message, thereby providing a spam classification for the message and handling the message based on the spam classification.

In accordance with a preferred embodiment of the present invention the network references include at least one translatable network address and the match is between at least one translatable network address and another at least one of the network references. Additionally, the at least one translatable network address includes a registered network address. Alternatively, the at least one translatable network address includes an Internet domain name. In accordance with another preferred embodiment of the present invention the classifying also includes translating the translatable network address, thereby providing a translated network address.

In accordance with a preferred embodiment of the present invention the handling includes at least one of forwarding the message to an addressee of the message, storing the message in a predefined storage area, deleting the message, rejecting the message, sending the message to an originator of the message and delaying the message for a period of time and thereafter re-classifying the message.

Preferably, the message includes at least one of an e-mail, a network packet, a digital telecom message and an instant messaging message.

In accordance with another preferred embodiment of the present invention the classifying also includes at least one of requesting feedback from an addressee of the message, evaluating compliance of the message with a predefined policy, evaluating registration status of at least one registered address in the message, analyzing a match among network references in the message, analyzing a match between at least one translatable address in the message and at least one other network reference in the message, at least partially actuating an unsubscribe feature in the message, analyzing an unsubscribe feature in the message, employing a variable criteria, sending information to a server and receiving classification data based on the information, employing classification data received from a server and employing stored classification data.

There is further provided in accordance with another preferred embodiment of the present invention a system for combating spam including a message evaluator, operative to evaluate a message using at least one message parameter, the at least one message parameter including at least one variable criterion, a message classifier, operative to provide a spam classification of the message at least partially based on an output of the message evaluator and a message handler, operative to handle the message based on the spam classification.

In accordance with a preferred embodiment of the present invention the at least one variable criterion includes a criterion which changes over time. Additionally or alternatively, the at least one variable criterion includes a parameter template-defined function.

There is yet further provided in accordance with yet another preferred embodiment of the present invention a system for combating spam including a message evaluator, operative to evaluate multiple messages using at least one message parameter of the multiple messages, the at least one message parameter including at least one variable criterion which changes over time, a message classifier, operative to provide spam classifications of the messages at least partially based on outputs of the message evaluator and a message handler, operative to handle the messages based on the spam classifications.

In accordance with a preferred embodiment of the present invention the spam classifications are at least partially based on similarities between plural messages among the multiple messages, which similarities are reflected in the at least one message parameter. Alternatively or additionally, the spam classifications are at least partially based on similarities between plural messages among the multiple messages, which similarities are reflected in outputs of applying the at least one evaluation criterion to the at least one message parameter. Alternatively or additionally, the spam classifications are at least partially based on similarities in multiple outputs of applying a single evaluation criterion to the at least one message parameter in multiple messages. In accordance with another preferred embodiment of the present invention the spam classifications are at least partially based on the extent of similarities between plural messages among the multiple messages which similarities are reflected in the at least one message parameter. Alternatively or additionally, the spam classifications are at least partially based on the extent of similarities between plural messages among the multiple messages which similarities are reflected in outputs of applying the at least one evaluation criterion to the at least one message parameter. In accordance with yet another preferred embodiment of the present invention the spam classifications are at least partially based on the extent of similarities in multiple outputs of applying a single evaluation criterion to the at least one message parameter in multiple messages.

In accordance with another preferred embodiment of the present invention the extent of similarities includes a count of messages among the multiple messages which are similar.

In accordance with still another preferred embodiment of the present invention the spam classifications are at least partially based on similarities in outputs of applying evaluation criteria to the at least one message parameter in multiple messages, wherein a plurality of different evaluation criteria are individually applied to the at least one message parameter in the multiple messages, yielding a corresponding plurality of outputs indicating a corresponding plurality of similarities among the multiple messages.

In accordance with a preferred embodiment of the present invention the system also includes an aggregator, operative to aggregate individual similarities among the plurality of similarities. Additionally, the aggregator is operative to apply a weighting to the individual similarities. Alternatively, the aggregator is operative to calculate a polynomial over the individual similarities.

In accordance with another preferred embodiment of the present invention the spam classifications are at least partially based on extents of similarities in outputs of applying evaluation criteria to the at least one message parameter in multiple messages, wherein a plurality of different evaluation criteria are individually applied to the at least one message parameter in the multiple messages, yielding a corresponding plurality of outputs indicating a corresponding plurality of extents of similarities among the multiple messages. In accordance with yet another preferred embodiment of the present invention the message classifier also includes an aggregator, operative to aggregate individual extents of similarities among the plurality of extents of similarities. In accordance with still another preferred embodiment of the present invention the aggregator is operative to apply a weighting to the individual extents similarities. Alternatively, the aggregator is operative to calculate a polynomial over the individual extents of similarities.

In accordance with still another preferred embodiment of the present invention the extents of similarities include a count of messages among the multiple messages which are similar.

In accordance with a preferred embodiment of the present invention the at least one variable criterion includes a parameter template-defined function.

In accordance with yet another preferred embodiment of the present invention the message classifier is operative to employ a function of outputs of evaluating at least one message parameter of the multiple messages. Additionally, the spam classifications are at least partially based on similarities between outputs of the evaluating at least one message parameter of multiple messages.

In accordance with another preferred embodiment of the present invention the message evaluator includes at least one gateway and the message classifier includes at least one server and the at least one server is operative to receive the output from the at least one gateway and to provide the spam classification to the at least one gateway. Additionally, the at least one gateway also includes an encrypter, operative to encrypt at least part of the output by employing a non-reversible encryption so as to generate encrypted information and a transmitter, operative to transmit at least the encrypted information to the at least one server. In accordance with a preferred embodiment of the present invention the transmitter is operative to transmit information of a length limited to a predefined threshold.

There is even further provided in accordance with still another preferred embodiment of the present invention a system for combating spam including a message categorizer, operative to categorize incoming messages received at at least one gateway into at least first, second and third categories and a message classifier, operative to provide spam classifications for incoming messages in at least the first and second categories, the message classifier being operative to store incoming messages in the third category and at a time thereafter to provide spam classifications for the incoming messages in the third category.

In accordance with another preferred embodiment of the present invention the system also includes a message handler, operative to handle the incoming messages based on the spam classifications.

In accordance with yet another preferred embodiment of the present invention the message classifier is operative to provide a spam classification for a second message received at the at least one gateway at the time thereafter. In accordance with another preferred embodiment of the present invention the time thereafter includes a time not later than after a maximum predetermined waiting period.

There is also provided in accordance with another preferred embodiment of the present invention a system for combating spam including a message classifier, operative to provide a spam classification for a message at least partially by relating to an unsubscribe feature in the message and a message handler, operative to handle the message based on the spam classification.

In accordance with another preferred embodiment of the present invention the system also includes an unsubscribe identifier, operative to identify whether the message includes an unsubscribe feature.

In accordance with still another preferred embodiment of the present invention the system also includes an addressee identifier, operative to identify whether the unsubscribe feature includes a reference to an addressee of the message. In accordance with a preferred embodiment of the present invention the reference to an addressee of the message includes an e-mail address. Alternatively, the reference to an addressee of the message includes a per-addressee generated ID. Additionally, the per-addressee generated ID includes a user identification number.

There is further provided in accordance with another preferred embodiment of the present invention a system for combating spam including a message classifier, operative to provide a spam classification for a message at least partially by at least partial actuation of an unsubscribe feature in the message and a message handler, operative to handle the message based on the spam classification.

In accordance with another preferred embodiment of the present invention the system also includes an actuation analyzer operative to analyze an output of the at least partial actuation. Additionally, the analyzer is operative to sense whether part of the output indicates the occurrence of an error. In accordance with another preferred embodiment of the present invention the at least partial actuation also includes at least attempting communication with a network server. In accordance with a preferred embodiment of the present invention the error indicates that the network server does not exist. Alternatively, the error indicates that the network server does not provide an unsubscribe functionality. Alternatively, the error indicates that the network server cannot unsubscribe a message addressee.

In accordance with another preferred embodiment of the present invention the analyzer is operative to sense whether part of the output includes an addressee reference. In accordance with a preferred embodiment of the present invention the addressee reference includes an e-mail address. Alternatively, the addressee reference includes a per-addressee generated ID. Additionally, the per-addressee generated ID includes a user identification number.

In accordance with another preferred embodiment of the present invention the analyzer is operative to relate the addressee reference to at least one addressee reference characteristic of the message. In accordance with another preferred embodiment of the present invention the at least one addressee reference characteristic of the message includes an e-mail address. Alternatively, the at least one addressee reference characteristic of the message includes a per-addressee generated ID. Additionally, the per-at least one addressee reference characteristic of the per-addressee generated ID includes a user identification number.

In accordance with another preferred embodiment of the present invention the system also includes an unsubscribe recognizer, operative to recognize the unsubscribe feature. Additionally, the unsubscribe recognizer is operative to sense a part of the message including predefined keywords. Additionally, the unsubscribe recognizer is operative to sense a part of the message including a network reference and a reference to an addressee of the messages. In accordance with a preferred embodiment of the present invention the network reference includes a reference to a network server. Alternatively or additionally, the reference to an addressee of the message includes an addressee e-mail address.

There is still further provided in accordance with yet another preferred embodiment of the present invention a system for combating spam including a message classifier, operative to provide a spam classification for a message at least partially by relating to registration status of at least one registered address in the message and a message handler, operative to handle the message based on the spam classifications.

In accordance with a preferred embodiment of the present invention the message classifier is operative to employ a network service for determining the registration status. Additionally or alternatively, the registration status includes a registration date. In accordance with a preferred embodiment of the present invention the registration status includes a registration expiry date.

In accordance with another preferred embodiment of the present invention the message classifier is operative to inspect whether registration of the registered address has expired. Alternatively or additionally, the message classifier is operative to inspect whether the registered address has not been registered. Additionally, the message classifier is operative to compare the registration date to a predefined date. In accordance with another preferred embodiment of the present invention the predefined date is a current date.

In accordance with another preferred embodiment of the present invention the registered address includes an Internet domain name. In accordance with another preferred embodiment of the present invention, the Internet domain name is parked.

There is yet further provided in accordance with another preferred embodiment of the present invention a system for combating spam including a message classifier, operative to provide a spam classification for a message at least partially by relating to a match among network references in the message and a message handler, operative to handle the message based on the spam classification.

In accordance with a preferred embodiment of the present invention the network references include at least one translatable network address and wherein the match is between at least one translatable network address and another at least one of the network references. Preferably, the at least one translatable network address includes a registered network address. Alternatively, the at least one translatable network address includes an Internet domain name.

In accordance with another preferred embodiment of the present invention the system also includes an address translator, operative to translate the translatable network address, thereby providing a translated network address.

In accordance with a preferred embodiment of the present invention the message handler is operative to perform at least one of the following: forward the message to an addressee of the message, store the message in a predefined storage area, delete the message, reject the message, send the message to an originator of the message and delay the message for a period of time and thereafter re-classify the message.

In accordance with a preferred embodiment of the present invention the message includes at least one of: an e-mail, a network packet, a digital telecom message and an instant messaging message.

In accordance with a preferred embodiment of the present invention the message classifier is operative to provide the spam classification at least partially based on at least one of the following: feedback requested from an addressee of the message, compliance of the message with a predefined policy, a registration status of at least one registered address in the message, a match among network references in the message, a match between at least one translatable address in the message and at least one other network reference in the message, at least partial actuation an unsubscribe feature in the message, an analysis of an unsubscribe feature in the message, a variable criteria, information sent to a server and classification data received based on the information, classification data received from a server and stored classification data

### BRIEF DESCRIPTION OF THE DRAWINGS

The present invention will be understood and appreciated more fully from the following detailed description, taken in conjunction with the drawings in which:

FIGS. 1A, 1B and 1C are simplified pictorial illustrations of a system and methodology for combating spam in accordance with a preferred embodiment of the present invention;

FIG. 1D is a simplified flowchart of the system and methodology of FIGS. 1A-1C;

FIGS. 2A and 2B are simplified pictorial illustrations of a system and methodology for combating spam in accordance with a further preferred embodiment of the present invention;

FIG. 2C is a simplified flowchart of the system and methodology of FIGS. 2A and 2B;

FIG. 3 is a simplified pictorial illustration of a system and methodology for combating spam in accordance with yet a further preferred embodiment of the present invention;

FIG. 4 is a simplified pictorial illustration of a system and methodology for combating spam in accordance with a still further preferred embodiment of the present invention;

FIG. 5 is a simplified pictorial illustration of a system and methodology for combating spam in accordance with yet another preferred embodiment of the present invention; and

FIG. 6 is a simplified pictorial illustration of a system and methodology for combating spam in accordance with still another preferred embodiment of the present invention.

### DETAILED DESCRIPTION OF THE PREFERRED EMBODIMENTS

It is appreciated that throughout the specification and claims the term “spam” refers to an unsolicited transmission of a message.

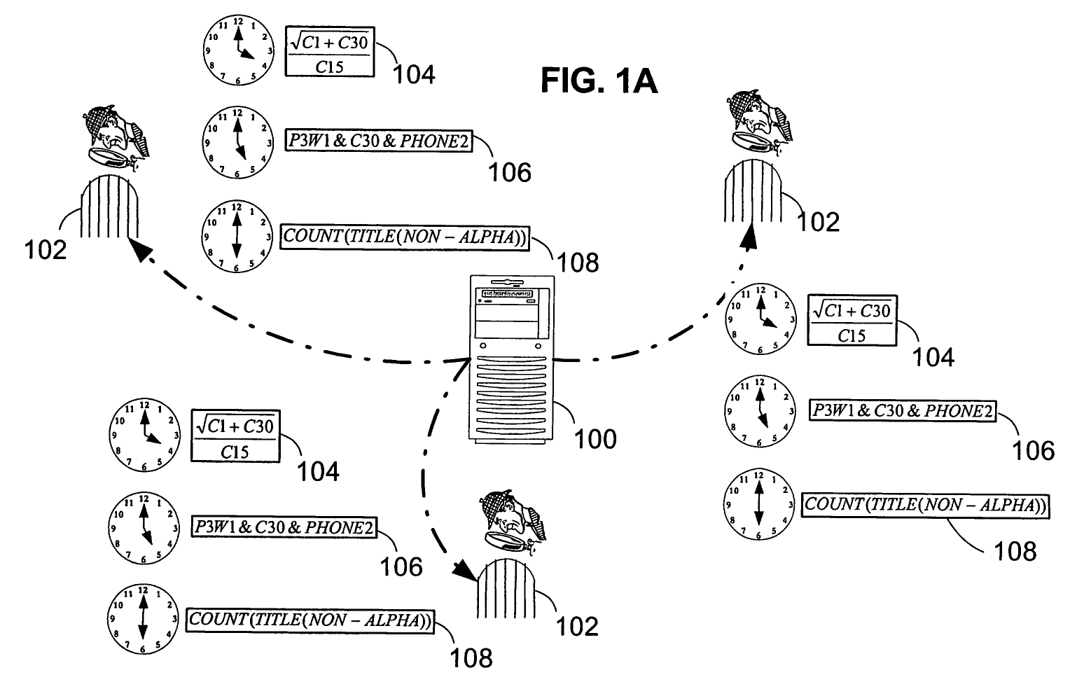

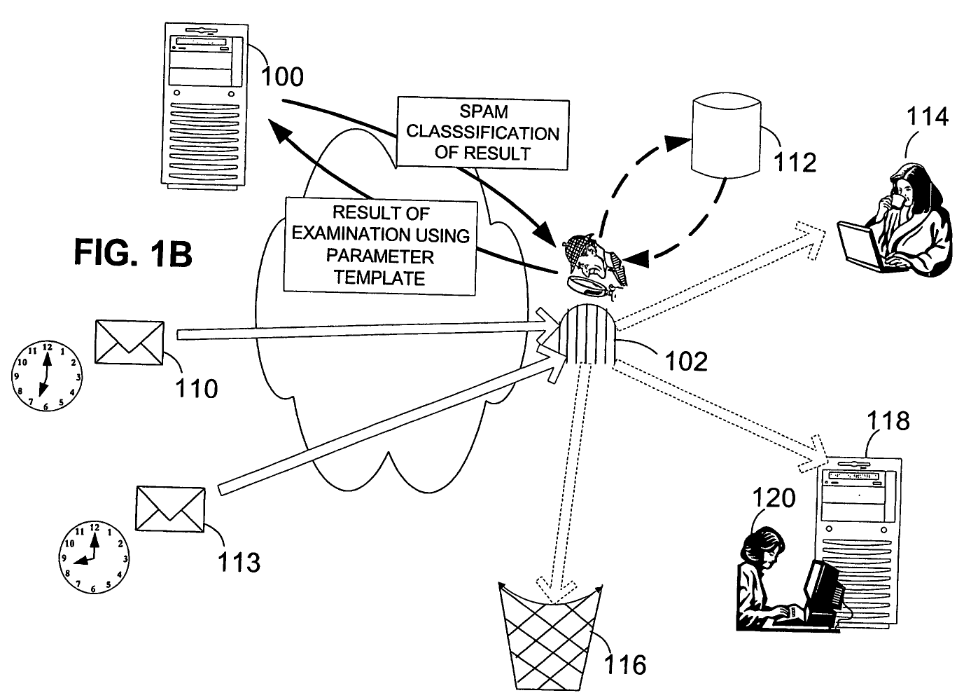

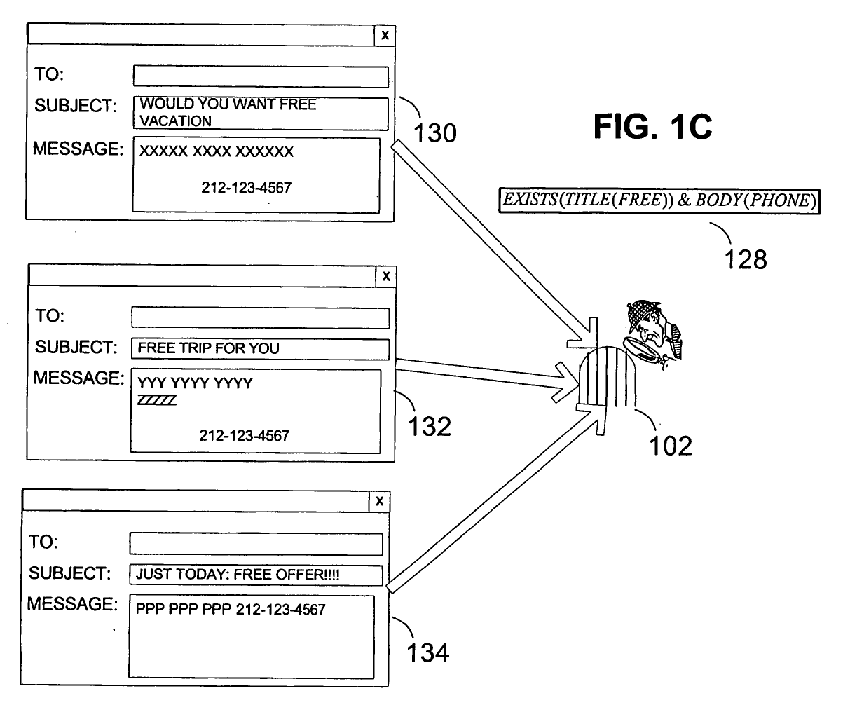

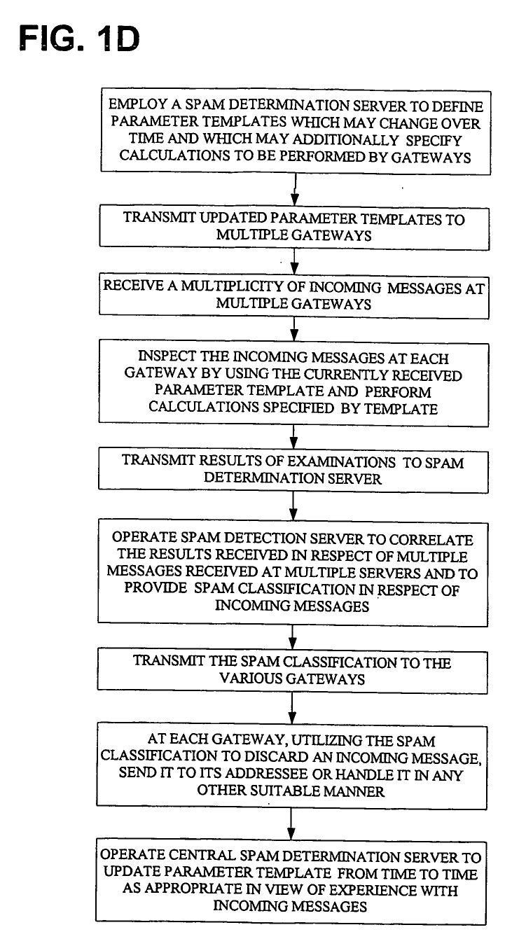

Reference is now made to FIGS. 1A-1D, which illustrate a system and methodology for combating spam in accordance with a preferred embodiment of the present invention. The system and methodology of the present invention employ an anti-spam technique which classifies incoming messages received at multiple gateways at a central server based on one or more message parameters, which parameters can be changed over time.

As seen in FIG. 1A, a spam detection server 100 updates, from time to time, a plurality of spam detection gateways 102 with parameter templates, such as parameter templates 104, 106 and 108.

It is appreciated that various types of parameter templates may be employed. For example, a template may include one or more of the following parameters: specific characters and/or words and/or character sequences at specific fixed or relative locations in the title, specific characters and/or words and/or character sequences at specific fixed or relative locations in the message body, e mail attributes in the body of the message, telephone number attributes in the body of the message, verbs in the body of the message and any other message attribute or part of a message attribute.

It is further appreciated that a relative location may be relative to any sub-object, such as a paragraph, a word or a formatting tag. It is also appreciated that a character sequence may be, for example, a fixed length sequence and/or a sequence delimited by a predetermined second character sequence and/or a sequence matching a pattern, such as a regular expression.

It is furthermore appreciated that a parameter template may also include instructions for calculating weightings and other values based on the various parameters.

One example of a parameter template, indicated in FIG. 1A by reference numeral 104, is as follows:

ADD THE NUMERICAL VALUE OF THE FIRST CHARACTER IN A MESSAGE BODY TO THE NUMERICAL VALUE OF THE THIRTIETH CHARACTER IN THE MESSAGE BODY;

CALCULATE THE SQUARE ROOT OF THE RESULT;

DIVIDE THE RESULT BY THE NUMERICAL VALUE OF THE FIFTEENTH CHARACTER IN THE MESSAGE BODY; AND

SET THE RESULT AS THE RESULT OF THE MESSAGE EXAMINATION.

Yet another example of a parameter template, indicated in FIG. 1A by reference numeral 106, is as follows:

CONCATENATE THE FIRST WORD OF THE THIRD PARAGRAPH OF A MESSAGE BODY AND THE THIRTIETH CHARACTER IN THE MESSAGE BODY;

CONCATENATE THE RESULT AND THE SECOND TELEPHONE NUMBER LOCATED IN THE MESSAGE BODY; AND

SET THE RESULT AS THE RESULT OF THE MESSAGE EXAMINATION.

Yet another example of a parameter template, indicated in FIG. 1A by reference numeral 108 is as follows:

LOCATE ALL NON-ALPHABETIC CHARACTERS IN A MESSAGE TITLE;

COUNT THE NUMBER OF CHARACTERS LOCATED; AND

SET THE RESULT AS THE RESULT OF THE MESSAGE EXAMINATION.

As seen in FIG. 1B, a message 110 received at a spam detection gateway 102 is examined based on at least one parameter template, such as any of templates 104, 106 or 108, which are updated from time to time by spam detection server 100. The result of the message examination is supplied by spam detection gateway 102 to spam detection server 100, which determines a spam classification for message 110.

The spam classification may be message examination result specific and/or may be message specific. It is appreciated that spam detection gateway 102 and/or spam detection server 100 may calculate weightings and other values based on spam classifications of results of examination of a message according to multiple parameter templates to determine the spam classification of the message.

For examples, results of examination of a message according to parameter templates 104, 106 and 108 for message 110 may be 0.2, “Forp800-123-4567” and 5 respectively. The spam classification of these results may be low, high and medium respectively and a numerical representation of the spam classifications of these results may be 2, 9 and 6 on a 1-10 scale. By providing relative weighting to these spam classifications, server 100 may calculate the spam classification of message 110. The weighting for parameter templates 104, 106 and 108 may be 0.3, 0.5 and 0.2 respectively, and the spam classification of message 110 would therefore be 2*0.3+9*0.5+6*0.2=6.1 on a 1-10 scale.

Spam classifications and/or examination results and/or message attributes may be stored at the server 100, a gateway 102 or using any other storage functionality 112 and employed for examination and/or classification of later received messages, such as a message 113.

Additionally or alternatively, spam detection server 100 may transmit spam classifications to multiple ones of the plurality of spam detection gateways 102.

It is appreciated that according to a preferred embodiment of the present invention, a spam detection gateway 102 may employ a non-reversible encryption algorithm so as to generate an encrypted transformation of at least part of a message parameter. It is appreciated that the encrypted information may be shorter than any reversible transformation of at least part of a message parameter, so as to consume less network resources when transmitted through a network. It is further appreciated that the encrypted information is incomprehensive to spam detection server 100 so as to avoid revealing any confidential information contained in a message. It is further appreciated that the amount of information transmitted from a gateway 102 to server 100 may be limited according to a predefined threshold.

Based on a spam classification of a message, spam detection gateway 102 may perform any one or more of the following actions with the message 110: a message having low spam certainty may be forwarded to an addressee, such as a user 114, a message having high spam certainty may be deleted, as indicated by being sent to a symbolic trash bin 116, and a message having intermediate spam certainty may be parked in an appropriate storage medium 118 until an appropriate later time when a new classification is made automatically or as the result of manual inspection by an administrator 120.

It is further appreciated that spam detection server 100 may make spam determinations by correlating the results of examination of a multiplicity of messages received by gateways 102 using a single or multiple parameter templates. High correlations tend to indicate the existence of spam and result in a spam classification being sent by server 100 to gateways 102.

It is appreciated that spam detection server 100 may employ any one or more of the following methods to correlate results of examination: an exact match, an approximate match and a cross-match. The spam detection server 100 may employ any other suitable correlation method. An exact match may be determined by comparing each character of a string representation of a result of examination for a first message with the character in the same position of the string representation of a result of examination for a second message. It is further appreciated that if all the comparisons are positive, the results match. Alternatively or additionally, an exact match may be determined by comparing a value calculated by applying a non-reversible encryption function to a result of examination of a first message and a non-reversible encryption function to a result of examination of a second message. Alternatively or additionally, an exact match may be determined by comparing any suitable one-to-one transformations of a result of examination of a first message with a one-to-one transformation of a result of examination of a second message.

It is appreciated that an approximate match may be determined by comparing an equivalent of a result of examination of a first message to an equivalent of a result of examination of a second message. Alternatively or additionally, an approximate match may be determined by comparing any suitable many-to-many transformation of a result of examination of a first message with a many-to-many transformation of a result of examination of a second message.

It is appreciated that a cross-match may be determined by comparing any suitable transformation of a result of examination of a first message using a first parameter template with o a suitable transformation of a result of examination of a second message using a second parameter template.

Referring to FIG. 1C, another example of a parameter template 128 may be:

CONCATENATING THE WORD “FREE” IF IT EXISTS IN A MESSAGE TITLE AND THE FIRST TELEPHONE NUMBER LOCATED IN THE MESSAGE BODY.

As further seen in FIG. 1C, if spam detection gateway 102 receives non-identical messages 130, 132 and 134, notwithstanding the differences in the messages 130, 132 and 134 the result of examination thereof may yield identical calculated values. In the event that a significant number of messages having this calculated value are received within a predetermined time, gateway 102 classifies all of these messages, notwithstanding their differences, as being spam.

It is appreciated that spam detection gateway 102 need not be located along the original route of a message. A message may be redirected to spam detection gateway 102 by any suitable gateway through which the message passes. Additionally or alternatively, a gateway may send a copy of the message to gateway 102.

Reference is now made to FIG. 1D, which is a simplified flowchart illustrating the functionality of the embodiment of FIGS. 1A-1C. As seen in FIG. 1D, spam determination server 100 may be employed to define parameter templates which may change over time and which may additionally specify calculations to be performed by spam detection gateways 102. Updated parameter templates are provided from time to time to multiple gateways 102, which receive a multiplicity of incoming messages. The gateways 102 inspect the incoming messages using the current parameter templates and perform calculations specified by the templates.

Results of the examination are transmitted by the spam detection gateways 102 to the spam detection server 100, which may correlate the results received in respect of plural messages from multiple servers and which provides spam classifications, which are supplied to the spam detection gateways 102.

The individual gateways employ the spam classifications to discard an incoming message, send it to its addressee or handle it in any other suitable manner, as described hereinabove. The spam detection server updates the parameter templates from time to time, based inter alia on its experience with earlier incoming messages. It is appreciated that the embodiment of FIGS. 1A-1D is also applicable to a single gateway architecture. In such a case, changeable templates may be generated at the gateway and spam determinations may be made thereby without involvement of an external server, preferably based on correlations between multiple messages received at that gateway. Inputs from other gateways may also be employed.

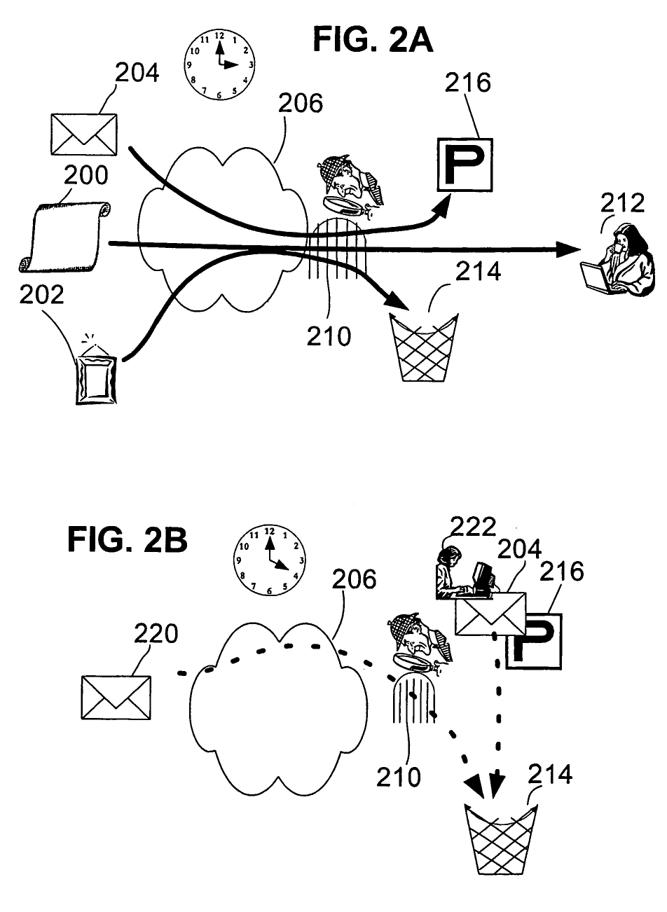

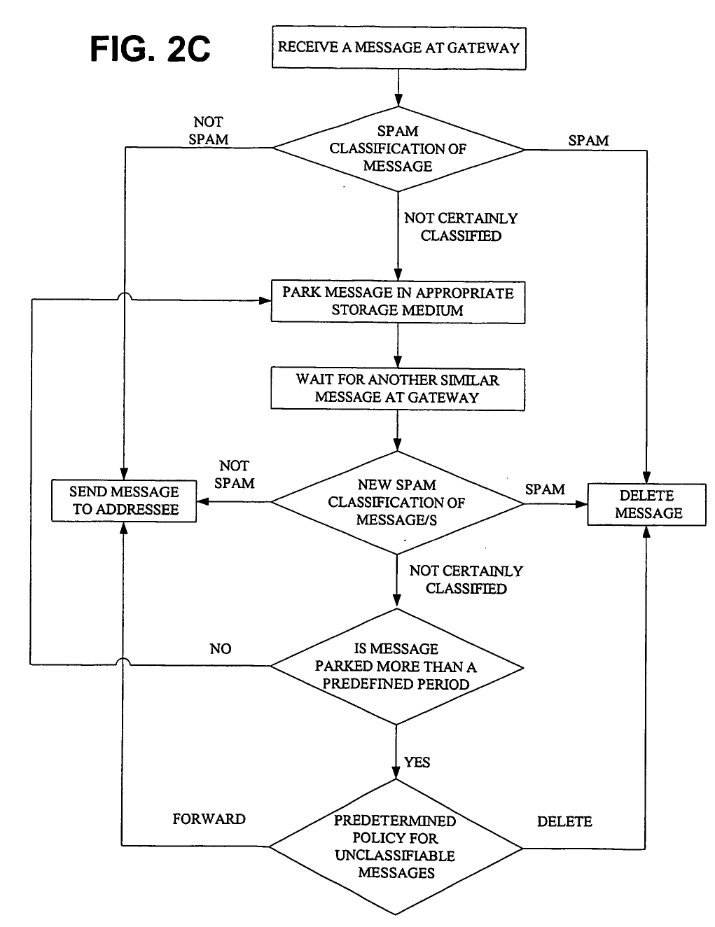

Reference is now made to FIGS. 2A and 2B, which together illustrate a system and methodology for combating spam in accordance with another preferred embodiment of the present invention. The system and methodology of this embodiment of the present invention employ another anti-spam technique, wherein suspect messages are “parked”, until further information which could assist in their classification becomes available. FIG. 2A illustrates receipt of three different types of messages 200, 202 and 204 via a network 206 by a spam classification gateway 210. Gateway 210 is operative to classify messages 200, 202 and 204, based on any appropriate method as described hereinbelow, and to take appropriate action with respect thereto. In the illustrated example, message 200 is classified by gateway 210 as being legitimate and is sent without delay through gateway 210 to an addressee, such as a user 212. Message 202 is classified by gateway 210 as being spam and is deleted by the gateway 210, as indicated by being sent to a symbolic trashcan 214. Message 204, which cannot be classified with acceptable certainty according to appropriate criteria based on the information available at gateway 210, is stored or “parked” on a suitable storage medium, such as a file server, symbolized by the P sign 216.

Examples of an appropriate method employed by gateway 210 may include any one or more of the following, optionally together with one or more methodologies described hereinabove with reference to FIGS. 1A-1D: analysis of the message content; analysis of the message header; transmission of the message and/or parts of it, preferably in non-reversible encrypted form, to a server; determination of compliance of the message content and/or the message headers with a predefined policy and requesting feedback from the message addressee.

Within a suitable time, such as one hour, as indicated in FIG. 2B, if further information, such as a similar message 220 is received at the gateway 210, a decision may be made based on appropriate criteria to delete both message 204 and subsequently received message 220. Alternatively, a decision may be made at any suitable time based on appropriate criteria to send message 204 to an addressee, such as user 212 (FIG. 2A), or to send the message for further evaluation.

Based on a spam classification of a message, spam detection gateway 210 may perform any one or more of the following actions with a message: a message having low spam certainty may be forwarded to addressee, such as user 212 (FIG. 2A), a message having high spam certainty may be deleted, as indicated by being sent to a symbolic trash bin 214, and a message having intermediate spam certainty may be parked in an appropriate storage medium 216 until an appropriate later time when a new classification is made automatically or as the result of manual inspection by an administrator 222.

Reference is now made to FIG. 2C, which illustrates the operation of the functionality of the embodiment of FIGS. 2A & 2B. Spam classification gateway 210 receives a message and preferably performs a classification triage. If the message is classified as spam it is deleted and if the message is classified as not being spam it is sent to the message addressee. If a sufficiently definite classification of a message is not possible, the message is preferably parked in an appropriate storage medium while further messages may be awaited.

The parked message and subsequently received messages, if any, may be again spam classified preferably in a classification triage. If the message is classified as spam, it is deleted and if the message is classified as not being spam it is sent to the message addressee. If a sufficiently definite classification of a message is not possible, the message is preferably parked in an appropriate storage medium while further messages are awaited. Should the accumulated parking time of a given message exceed a predetermined threshold, the message is handled according to a predetermined policy for unclassifiable messages and either deleted or sent to the addressee in accordance with that policy.

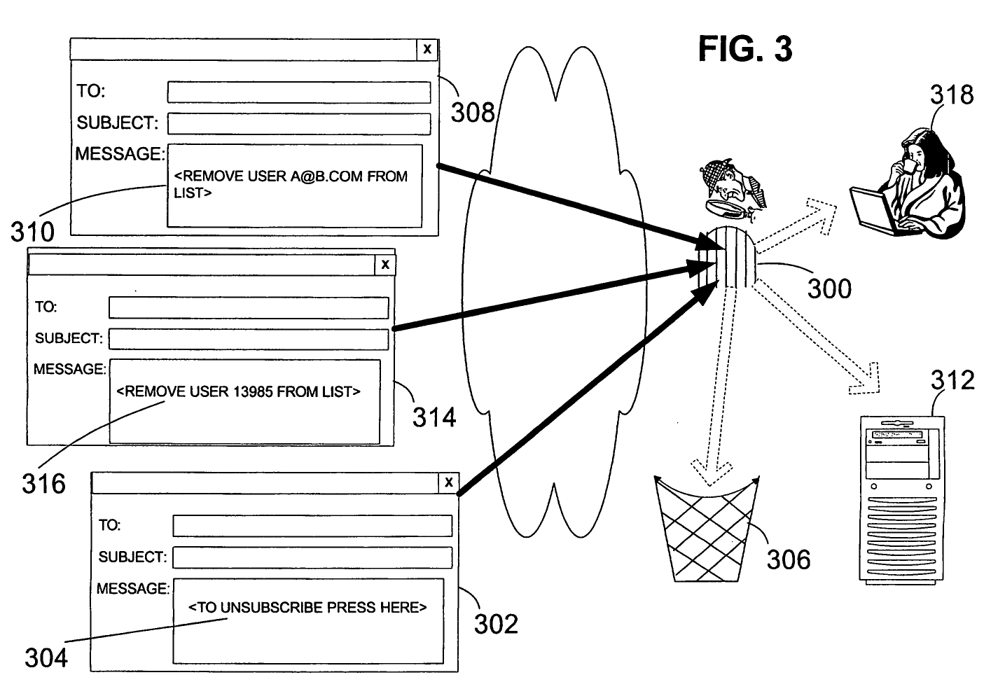

Reference is now made to FIG. 3, which illustrates a system and methodology for combating spam in accordance with yet another preferred embodiment of the present invention. The system and methodology of this embodiment of the present invention employ a further anti-spam technique in accordance with the present invention, wherein messages containing various types of ‘unsubscribe’ functionalities are classified by a spam inspecting gateway 300. As seen in FIG. 3, a first message 302, having a general unsubscribe feature 304, which does not contain any information regarding the message addressee, is classified by spam inspecting gateway 300 as having a high likelihood of being spam and is therefore discarded, as indicated by being sent to a symbolic trash can 306. A second message 308, having an unsubscribe feature 310 which includes an addressee's email address, is classified by gateway 300 as having an intermediate likelihood of being spam and is sent to a temporary storage location, symbolized by server 312, to await manual classification by an email administrator. The presence of the addressee's email address may indicate the existence of a recipient database which is not characteristic of spam. A third message 314, having an unsubscribe feature 316 which includes a user identification number, is presumed to indicate the existence of a user database and is therefore presumed not to be spam. This message is therefore sent to an addressee, such as a user 318.

The foregoing methodology may be combined with any one or more of the methodologies described hereinabove with reference to FIGS. 1A-2C.

It is further appreciated that the unsubscribe feature in a message may include a network reference, such an address of a web service which enables a user to be removed from a list generating the message and/or from other address lists. Alternatively or additionally, an unsubscribe functionality include a mail address to which an unsubscribe request may be sent in order to remove the user from a mailing list generating the message and/or from other address lists.

It is further appreciated that an unsubscribe feature may be identified by locating predefined keywords in a message. Examples of a typical predefined keyword may include “unsubscribe”, “exclude”, “future mailing” and any other suitable keyword. Alternatively or additionally, an unsubscribe feature may be identified by a reference to a message addressee.

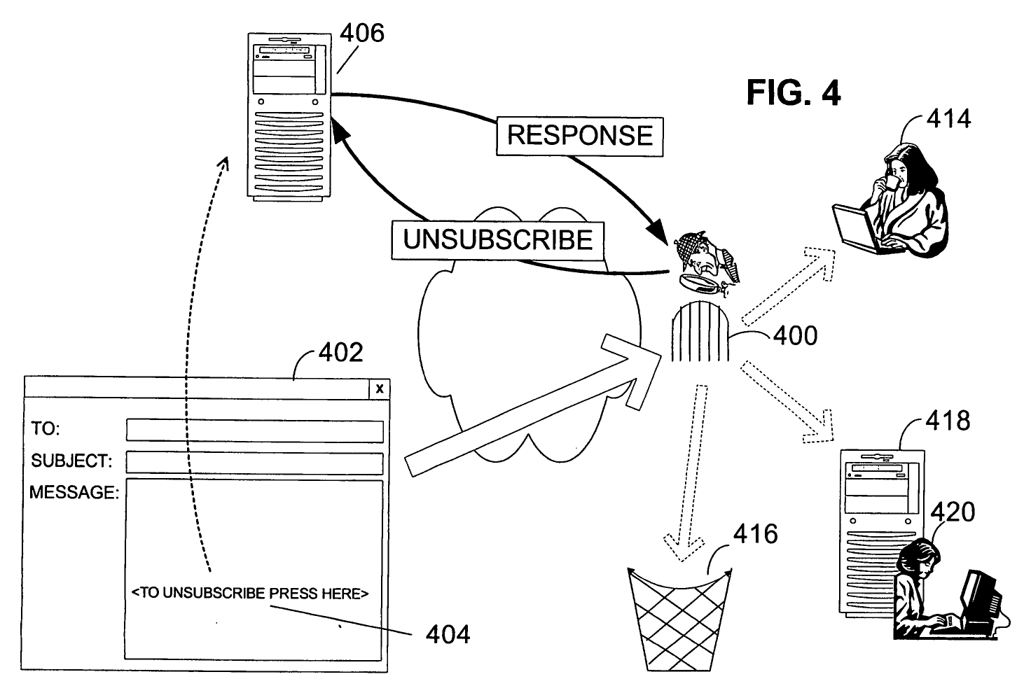

Reference is now made to FIG. 4, which illustrates a system and methodology for combating spam in accordance with yet another preferred embodiment of the present invention. The system and methodology of this embodiment of the present invention employ an additional anti-spam technique related to the presence of unsubscribe functionality in incoming messages. A spam inspecting gateway 400 inspects an incoming message 402 having an unsubscribe feature 404 in order to determine a spam classification of the message. The inspecting gateway 400 initially actuates the unsubscribe feature by communicating with a server 406 which is typically addressed by the unsubscribe feature 404. A spam classification is determined based on a response received from server 406. In the illustrated example, receipt of an error response indicating that the unsubscribe function does not exist may indicate a relatively high spam certainty. An error response indicating that the unsubscribe function does exist but is not operating properly may indicate an intermediate spam certainty and an error message indicating successful initial actuation of the unsubscribe function may indicate a relatively low spam certainty, without actually causing the addressee to be unsubscribed.

The foregoing methodology may be combined with any one or more of the methodologies described hereinabove with reference to FIGS. 1A-3.

Based on a spam classification of a message, spam inspecting gateway 400 may perform any one or more of the following actions with a message: a message having low spam certainty may be forwarded to addressee, such as a user 414, a message having high spam certainty may be deleted, as indicated by being sent to a symbolic trash bin 416, and a message having intermediate spam certainty may be parked in an appropriate storage medium 418 until an appropriate later time when a new classification is made automatically or as the result of manual inspection by an administrator 420.

It is further appreciated that the unsubscribe feature in a message may include a network reference, such an address of a web service which enables a user to be removed from a list generating the message and/or from other address lists. Alternatively or additionally, an unsubscribe functionality may include a mail address to which an unsubscribe request may be sent in order to remove the user from a mailing list generating the message and/or from other address lists.

It is further appreciated that an unsubscribe feature may be identified by locating predefined keywords in a message. Examples of a typical predefined keyword may include “unsubscribe”, “exclude”, “future mailing” and any other suitable keyword. Alternatively or additionally, an unsubscribe feature may be identified by a reference to a message addressee.

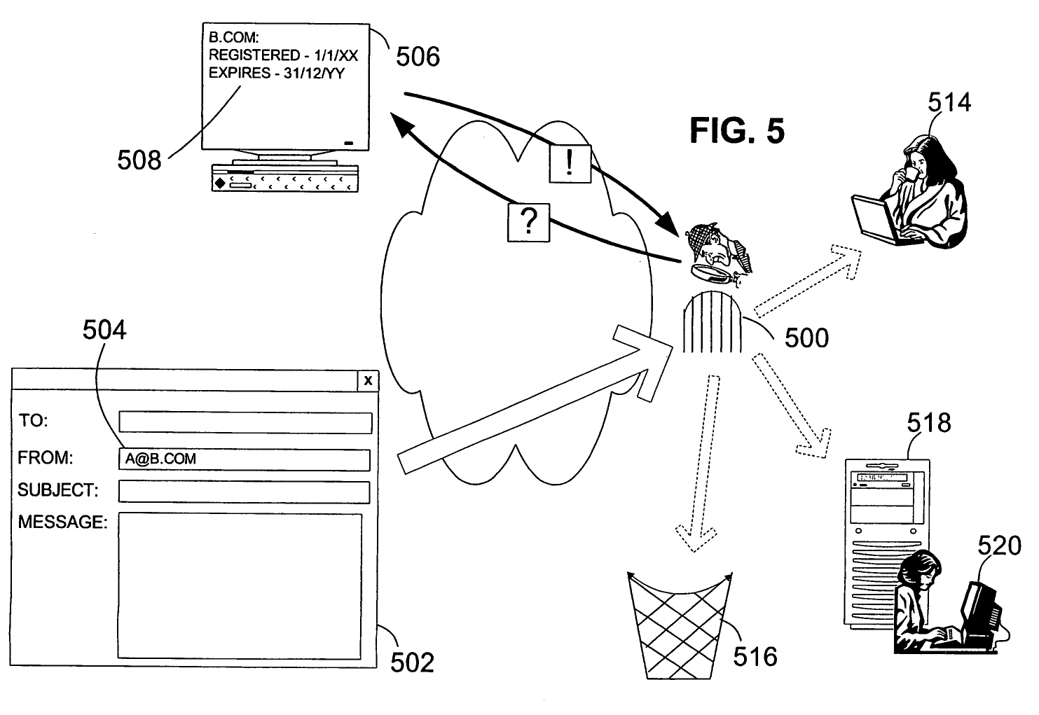

Reference is now made to FIG. 5, which illustrates a system and methodology for combating spam in accordance with yet another preferred embodiment of the present invention. The system and methodology of this embodiment of the present invention employ an additional anti-spam technique related to registration status of the domain name or any other registered address in an incoming message. An inspector gateway 500 inspects an incoming message 502 having a domain indication 504 or any other registered address. The inspector gateway 500 may employ a look up directory such as directory 506 to check the registration date 508 and/or the expiry date 508 of the domain indication 504. Relatively newly registered addresses may indicate a high certainty of spam. Additionally or alternatively, a registered address for which registration has expired may indicate a high certainty of spam. Additionally or alternatively, a parked status, as explained below, may indicate a higher level of indication of spam.

The foregoing methodology may be combined with any one or more of the methodologies described hereinabove with reference to FIGS. 1A-4.

A message having low spam certainty may be forwarded to addressee, such as a user 514, a message having high spam certainty may be deleted, as indicated by being sent to a symbolic trash bin 516, and a message having intermediate spam certainty may be parked in an appropriate storage medium 518 until an appropriate later time when a new classification is made automatically or as the result of manual inspection by an administrator 520.

It is further appreciated that a registered network address may be a network reference at least a part of which requires registration at a registry prior to use. A registered network address may be an Internet domain name and/or any network address that comprises an Internet domain name, such as an Internet e-mail address or a URL. An expired registered address may be a registered address for which a periodic registration was required and was not performed. It is further appreciated that the registration date of a registered network address may be the date on which the address was first registered. The term “parked status” typically refers to a domain that was registered but does not refer to an operative web site.

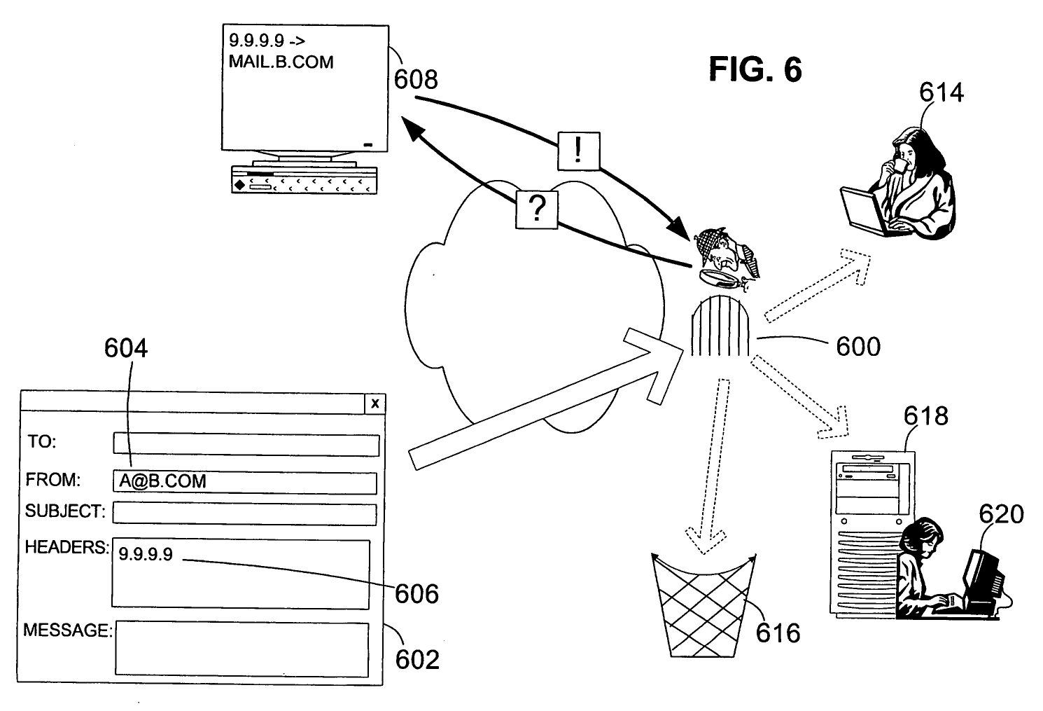

Reference is now made to FIG. 6, which illustrates a system and methodology for combating spam in accordance with yet another preferred embodiment of the present invention. The system and methodology of this embodiment of the present invention employ an additional anti-spam technique related to matching of various addresses appearing in an incoming message. An inspector gateway 600 inspects an incoming message 602 having a domain name indication 604 or any other translatable reference and at least one other reference, such as IP address 606. The inspector gateway 600 may employ a look up directory 608 to translate the domain name indication 604 and/or any other translatable reference and then may compare one or more translated references to any one or more references and/or other translated references in message 602 in order to ascertain the presence of matches. Matches indicate a relatively low spam certainty.

The foregoing methodology may be combined with any one or more of the methodologies described hereinabove with reference to FIGS. 1A-5.

A message having low spam certainty may be forwarded to addressee, such as a user 614, a message having high spam certainty may be deleted, as indicated by being sent to a symbolic trash bin 616, and a message having intermediate spam certainty may be parked in an appropriate storage medium 618 until an appropriate later time when a new classification is made automatically or as the result of manual inspection by an administrator 620.

It is further appreciated that a translatable reference may be a reference at least a part of which may be translated by querying a translation service. A symbolic Internet host name, for example, can be translated to a numeric IP address by employing an Internet domain registry service. As another example, a translatable reference may be any network address including a symbolic Internet host name such as an e-mail address or a URL.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A method for combating spam comprising:
classifying a message at least partially by evaluating at least one message parameter, using at least one variable criterion, thereby providing a spam classification; and
handling said message based on said spam classification.

2. A method for combating spam according to claim 1 and wherein said at least one variable criterion comprises a criterion which changes over time.

3. A method for combating spam according to claim 1 and wherein said at least one variable criterion comprises a parameter template-defined function.

4. A method for combating spam according to claim 1 and wherein said classifying comprises:
said using at least one variable criterion at at least one gateway; and
said providing spam classifications at at least one server, receiving evaluation outputs from said at least one gateway and providing said spam classifications to said at least one gateway.

5. A method for combating spam according to claim 4 and wherein said classifying also comprises:
encrypting at least part of said evaluation outputs by employing a non-reversible encryption so as to generate encrypted information; and
transmitting at least said encrypted information to said at least one server.

6. A method for combating spam according to claim 5 and wherein said transmitting comprises transmitting information of a length limited to a predefined threshold.

7. A method for combating spam according to claim 1 and wherein said handling comprises at least one of:
forwarding said message to an addressee of said message;
storing said message in a predefined storage area;
deleting said message;
rejecting said message;
sending said message to an originator of said message; and
delaying said message for a period of time and thereafter re-classifying said message.

8. A method for combating spam according to claim 1 and wherein said message comprises at least one of:
an e-mail;
a network packet;
a digital telecom message; and
an instant messaging message.

9. A method for combating spam according to claim 1 and wherein said classifying also comprises at least one of:
requesting feedback from an addressee of said message;
evaluating compliance of said message with a predefined policy;
evaluating registration status of at least one registered address in said message;
analyzing a match among network references in said message;
analyzing a match between at least one translatable address in said message and at least one other network reference in said message;
at least partially actuating an unsubscribe feature in said message;
analyzing an unsubscribe feature in said message;
employing a variable criteria;
sending information to a server and receiving classification data based on said information;
employing classification data received from a server; and
employing stored classification data.

10. A method for combating spam comprising:
classifying messages at least partially by evaluating at least one message parameter of multiple messages, by employing at least one evaluation criterion which changes over time, thereby providing spam classifications; and
handling said messages based on said spam classifications.

11. A method for combating spam according to claim 10 and wherein said classifying is at least partially responsive to similarities between plural messages among said multiple messages, which similarities are reflected in said at least one message parameter.

12. A method for combating spam according to claim 10 and wherein said classifying is at least partially responsive to similarities between plural messages among said multiple messages, which similarities are reflected in outputs of applying said at least one evaluation criterion to said at least one message parameter.

13. A method for combating spam according to claim 10 and wherein said classifying is at least partially responsive to similarities in multiple outputs of applying a single evaluation criterion to said at least one message parameter in multiple messages.

14. A method for combating spam according to claim 10 and wherein said classifying is at least partially responsive to the extent of similarities between plural messages among said multiple messages which similarities are reflected in said at least one message parameter.

15. A method for combating spam according to claim 10 and wherein said classifying is at least partially responsive to the extent of similarities between plural messages among said multiple messages which similarities are reflected in outputs of applying said at least one evaluation criterion to said at least one message parameter.

16. A method for combating spam according to claim 10 and wherein said classifying is at least partially responsive to the extent of similarities in multiple outputs of applying a single evaluation criterion to said at least one message parameter in multiple messages.

17. A method for combating spam according to claim 14 and wherein said extent of similarities comprises a count of messages among said multiple messages which are similar.

18. A method for combating spam according to claim 10 and wherein said classifying is at least partially responsive to similarities in outputs of applying evaluation criteria to said at least one message parameter in multiple messages, wherein a plurality of different evaluation criteria are individually applied to said at least one message parameter in said multiple messages, yielding a corresponding plurality of outputs indicating a corresponding plurality of similarities among said multiple messages.

19. A method according to claim 18 and wherein said classifying also comprises aggregating individual similarities among said plurality of similarities.

20. A method according to claim 19 and wherein said aggregating individual similarities among said plurality of similarities comprises applying weights to said individual similarities.

21-186. (canceled)
